(19) United States
(12) Patent Application Publication
(10) Pub. No.: US 2025/0327612 A1
(43) Pub. Date: Oct. 23, 2025

(54) SOLAR POWERED COOLER WITH WATER FILTRATION SYSTEM

(71) Applicant: Tamitha Lambert, Latham, OH (US)

(72) Inventor: Tamitha Lambert, Latham, OH (US)

(21) Appl. No.: 18/639,603

(22) Filed: Apr. 18, 2024

(51) Int. Cl. F25D 3/08; B01D 39/20; C02F 1/00; F21S 9/03; F21V 33/00; F25D 27/00; H02S 40/30

(52) U.S. Cl. CPC F25D 3/08; B01D 39/2055; C02F 1/003; F21S 9/037; F21V 33/0004; F25D 27/00; H02S 40/30; C02F 2307/10

(57) ABSTRACT

A solar powered cooler with a water filtration system, including a main body, including an upper shelf disposed at an upper portion of the main body, a drain shelf disposed below the upper shelf to receive ice thereupon, the drain shelf including a removable charcoal filter to filter water from the ice as the ice melts, and a water compartment disposed below the drain shelf to collect the water as the ice disposed on the drain shelf melts, and a lid to open and close an opening of the main body, the lid including an illumination unit disposed on an inner surface of the lid to illuminate in response to a user powering on the illumination unit.

### BACKGROUND

### 1. Field

The present general inventive concept relates generally to a cooler, and particularly, to a solar powered cooler with a water filtration system.

### 2. Description of the Related Art

Conventional insulated coolers warrant the use of ice that is often thrown out once the ice has melted due to contamination concerns.

When it comes to camping or traveling, this waste is prevalent as many individuals will carry multiple coolers for food and drinks, and constantly keep changing the ice, which can be incredibly inconvenient.

Therefore, there is a need for a cooler that filters melted ice into drinkable water.

There is also a need for a cooler that is usable at night.

### SUMMARY

The present general inventive concept provides a solar powered cooler with a water filtration system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a solar powered cooler with a water filtration system, including a main body, including an upper shelf disposed at an upper portion of the main body, a drain shelf disposed below the upper shelf to receive ice thereupon, the drain shelf including a removable charcoal filter to filter water from the ice as the ice melts, and a water compartment disposed below the drain shelf to collect the water as the ice disposed on the drain shelf melts, and a lid to open and close an opening of the main body, the lid including an illumination unit disposed on an inner surface of the lid to illuminate in response to a user powering on the illumination unit.

The solar powered cooler with a water filtration system may further include a solar panel disposed on a surface of the lid and connected to the illumination unit to collect solar energy to provide power to the illumination unit.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a solar powered cooler with a water filtration system, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the FIGURES and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Ice 10
Water 11
Solar Powered Cooler with a Water Filtration System 100
Main Body 110
Handles 111
Charcuterie Compartment 112
Upper Shelf 113
Ice Compartment 114
Drain Shelf 115
Charcoal Filter 115a
Water Compartment 116
Spout 117
Drain Nozzle 118
Lid 120
Latches 121
Cup Holders 122
Solar Panel 123
Battery 124
Illumination Unit 125
Switch 125a

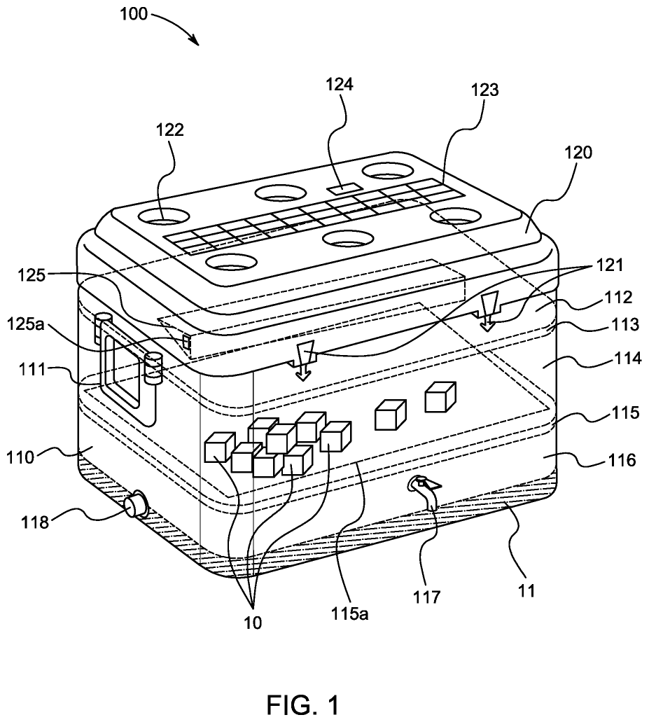

FIG. 1 illustrates a solar powered cooler with a water filtration system 100, according to an exemplary embodiment of the present general inventive concept.

The solar powered cooler with a water filtration system 100, and all components therein and/or connected thereto, may be constructed from at least one of metal, plastic, wood, silicone, cloth, circuitry, and rubber, etc., but is not limited thereto, and can be constructed from any material known to one of ordinary skill in the art.

Referring to FIG. 1, the solar powered cooler with a water filtration system 100 may include a main body 110 and a lid 120, but is not limited thereto.

The main body 110 may include a plurality of handles 111, a charcuterie compartment 112, an upper shelf 113, an ice compartment 114, a drain shelf 115, a water compartment 116, a spout 117, and a drain nozzle 118, but is not limited thereto.

The main body 110 may be constructed from material that is insulated, similar to any type of conventional cooler known to one of ordinary skill in the art.

The main body 110 may include a plurality of handles 111 disposed at portions of the main body 110. The plurality of handles 111 may be utilized by a user to pick up and carry the solar powered cooler with a water filtration system 100.

The charcuterie compartment 112 may be disposed at an upper portion of the main body 110, and may be separated from the rest of the main body 110 by the upper shelf 113 disposed at a bottom portion of the charcuterie compartment 112.

The upper shelf 113 may be adjustable within the main body 110, thereby making a size of the charcuterie compartment 112 also adjustable. Also, the upper shelf 113 may be removeable from the main body 110.

The ice compartment 114 may be disposed at a middle portion of the main body 110, may be designed to store ice 10 therewithin, and may be separated from the rest of the main body 110 by the upper shelf 113 disposed at a top portion of the ice compartment 114, and the drain shelf 115 disposed at a bottom portion of the ice compartment 114.

The charcuterie compartment 112 may be included to allow a user to place meats, cheeses, and fruits therewithin, such that the ice 10 within the ice compartment 114 keeps the entire inner portion of the main body 110, including the charcuterie compartment 112.

The drain shelf 115 may be adjustable within the main body 110, thereby making a size of the ice compartment 114 also adjustable. Also, the drain shelf 115 may be removeable from the main body 110.

The water compartment 116 may be a bottom-most compartment of the main body 100, and may be separated from the ice compartment 114 by the drain shelf 115.

The charcoal filter 115a may be removably disposed on the drain shelf 115, and/or may be integrally combined therewith, such that any ice 10 disposed within the ice compartment 114 is filtered through the charcoal filter 115a as it melts into the water 11 and drips into the water compartment 116, which is designed to store the water 11 therein.

The charcoal filter 115a may be any type of filter known to one of ordinary skill in the art that has an ability to turn contaminated water into drinkable water.

The spout 117 may be disposed at an outside bottom portion of the main body 110, and may allow a user to selectively dispense the water 11 from the water compartment 116 to outside the main body 110.

The drain nozzle 118 may allow for fast emptying of the water 11 (and any other leaked liquids) from the main body 110 to outside the main body 110.

The lid 120 may include a plurality of latches 121, a plurality of cup holders 122, a solar panel 123, a battery 124, and an illumination unit 125, but is not limited thereto.

The lid 120 may open to allow a user to access an inner portion of the main body 110, and the latches 121 may be disposed on an outer surface of the lid 120 to allow a user to lock the lid 120 to the main body 110.

The plurality of cup holders 122 may include indentations that may be disposed at a top portion of the lid 120 to allow a user to insert cups therein.

The solar panel 123 may be disposed at a top portion of the lid 120, and may be any type of solar panel known to one of ordinary skill in the art that harnesses solar energy from the sun and/or light sources, to charge the battery 124 that is stored within the lid 120 and connected to the solar panel 123.

The battery 124 may be rechargeable, or alternatively, any other type of battery known to one of ordinary skill in the art, and may be automatically recharged when the solar powered cooler with a water filtration system 100 is outside on a sunny day.

The illumination unit 125 may also be connected to the solar panel 123, as well as the battery 124, in order to illuminate an area surrounding the inner portion of the main body 125 when the illumination unit is turned on via the switch 125a. The illumination unit may be disposed to be angled within the lid 120, such that the illumination unit shines light downward when the lid 120 is opened. The illumination unit 125 may include LEDs, halogen lights, or any other type of lights that are known to one of ordinary skill in the art.

As such, a user can utilize the solar powered cooler with a water filtration system 100 to filter the melted ice 10 into the drinkable water 11.

Also, since the solar powered cooler with a water filtration system 100 recharges the battery 124 while the solar powered cooler with a water filtration system 100 is exposed to sunlight, the user is able to utilize the cooler at nighttime by powering on the illumination unit 125 when it is dark outside.

The present general inventive concept may include a solar powered cooler with a water filtration system 100, including a main body 110, including an upper shelf 113 disposed at an upper portion of the main body 110, a drain shelf 115 disposed below the upper shelf 113 to receive ice 10 thereupon, the drain shelf 115 including a removable charcoal filter 115a to filter water 11 from the ice 10 as the ice 10 melts, and a water compartment 116 disposed below the drain shelf 115 to collect the water 11 as the ice 10 disposed on the drain shelf 115 melts, and a lid 120 to open and close an opening of the main body 110, the lid 120 including an illumination unit 125 disposed on an inner surface of the lid 120 to illuminate in response to a user powering on the illumination unit 125.

The solar powered cooler with a water filtration system 100 may further include a solar panel 123 disposed on a surface of the lid 120 and connected to the illumination unit 125 to collect solar energy to provide power to the illumination unit 125.

A main purpose of the present general inventive concept is to provide users with a food management accessory that can transform ice stored, within, into clean drinking water. Ingenious and practical, the present general inventive concept offers a modern alternative cooler design that transforms melted ice into fresh drinkable water eliminating the need for separate coolers and excessive water waste, all while ensuring users have quick and easy access to pristine water. The present general inventive concept introduces a novel three-tiered cooler equipped with a cutting-edge internal charcoal filter system. The top layer provides ample space for food items, the middle section caters to drinks and ice, while the charcoal filter is strategically placed thereafter to purify the melted ice from the top two parts into the bottom drinking water reservoir. In addition, the present general inventive concept features a central solar panel that powers an internal LED light, ensuring visibility even in low-light conditions; yet, employs a rechargeable battery that serves as a backup, guaranteeing that users can effortlessly locate their items regardless of the time, day or night. This innovative, top-quality product can be used in any outdoor excursions and in times of emergency, a benefit to individuals across the globe. As a result, the present general inventive concept may prove to be essential in the novelty/recreational industry.

The present general inventive concept transforms melted ice in coolers into fresh, drinkable water without any risk of contamination from the layers above. This unprecedented product is uniquely designed to consolidate food and drink storage, eliminating the need for separate coolers, possesses a three-layered design for efficient organization, is carefully crafted with durable, high-quality materials to ensure long-term sustainability, and offers supportive features such as cup holders, easy to control transport handles, a removable shelf, and a primary pour spout for quick water accessibility.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A solar powered cooler with a water filtration system, comprising:
a main body, comprising:
an upper shelf disposed at an upper portion of the main body,
a drain shelf disposed below the upper shelf to receive ice thereupon, the drain shelf comprising a removable charcoal filter to filter water from the ice as the ice melts, and
a water compartment disposed below the drain shelf to collect the water as the ice disposed on the drain shelf melts; and
a lid to open and close an opening of the main body, the lid comprising:
an illumination unit disposed on an inner surface of the lid to illuminate in response to a user powering on the illumination unit.

2. The solar powered cooler with a water filtration system of claim 1, further comprising:
a solar panel disposed on a surface of the lid and connected to the illumination unit to collect solar energy to provide power to the illumination unit.
